(19) United States
(12) Patent Application Publication
(10) Pub. No.: US 2026/0119030 A1
(43) Pub. Date: Apr. 30, 2026

(54) ELECTRONIC DEVICE

(71) Applicant: Lenovo (Beijing) Limited, Beijing (CN)

(72) Inventors: Yuefeng SU, Beijing (CN); Ke SHANG, Beijing (CN)

(21) Appl. No.: 19/376,348

(22) Filed: Oct. 31, 2025

(30) Foreign Application Priority Data
Oct. 31, 2024 (CN) 202411549042.0

(51) Int. Cl. G06F 3/04886

(52) U.S. Cl. CPC G06F 3/04886

(57) ABSTRACT

An electronic device includes: a first body, the first body having a first surface; a display screen, the display screen being on the first body, the display screen having a first display area facing in a same direction as the first surface; a second body, the second body connected to the first body via a rotating connection structure; and an adjustment structure, the adjustment structure at least partially located in the second body or the rotating connection structure, the adjustment structure being configured to control the display screen to switch between a first state and a second state, where at the first state, the first display area has a first size, at the second state, the first display area has a second size, and the first size being different from the second size.

### CROSS-REFERENCE TO RELATED APPLICATION(S)

This application claims priority to Chinese Patent Application No. 2024115490420 filed on Oct. 31, 2024, which is incorporated herein by reference in its entirety.

### FIELD OF THE TECHNOLOGY

The present disclosure relates to a technical field of electronic devices, and in particular to an electronic device.

### BACKGROUND

With the development of consumer electronics, a wide variety of electronic devices are emerging. Foldable screens and rollable screens are hot topics in the industry, and yet such designs have their challenges.

Taking a laptop computer as an example, it has a first body for display and a second body with components such as the motherboard. By stowing the rollable screen, the screen is located within the second body. However, rollable screens offer limited stability in their use.

### SUMMARY

In one aspect, the present disclosure provides an electronic device. The device includes: a first body, the first body having a first surface; a display screen, the display screen configured on the first body, the display screen having a first display area facing in a same direction as the first surface; a second body, the second body connected to the first body via a rotating connection structure; and an adjustment structure, the adjustment structure at least partially located in the second body or the rotating connection structure, the adjustment structure being configured to control the display screen to switch between a first state and a second state, where at the first state, the first display area has a first size, at the second state, the first display area has a second size, and the first size being different from the second size.

In another aspect, the present disclosure provides an electronic device. The device includes a first body, including a first surface and a second surface opposing the first surface; a display screen, including a flexible portion, wherein the flexible portion includes a first portion supported on the first surface and a second portion supported on the second surface; and a second body, connected to the first body via a rotating connection structure, where the rotating connection structure is positioned between the flexible portion and the second body.

In yet another aspect, the present disclosure provides an electronic device. The device includes: a first body, including a first surface and a second surface opposing the first surface; a display screen, including a flexible portion, wherein the flexible portion includes a first portion supported on the first surface and a second portion supported on the second surface; a first shaft, configured to support movement of the flexible portion; and a second body, connected to the first body via a rotating connection structure, where the rotating connection structure is positioned between the flexible portion and the second body; and a transparent cover, configured to cover at least partially the second portion of the flexible portion.

### BRIEF DESCRIPTION OF THE DRAWINGS

In order to more clearly illustrate certain embodiments of the present disclosure, the following briefly introduces the drawings for use in certain embodiments. The drawings described below reflect certain embodiments of the present disclosure. For ordinary technicians in the field, other drawings may be obtained based on these drawings without any creative work.

FIG. 1 is a schematic diagram of a structure of an electronic device, provided in certain embodiments of the present disclosure;

FIG. 2 is a schematic diagram of a front view of an electronic device at a first state, provided in certain embodiments of the present disclosure;

FIG. 3 is a schematic diagram of a front view of an electronic device at a second state, provided in certain embodiments of the present disclosure;

FIG. 4 is a schematic diagram of a structure of an electronic device at a folded and stowed state, provided in certain embodiments of the present disclosure;

FIG. 5 is a schematic diagram of a rear view of an electronic device at a first state, provided in certain embodiments of the present disclosure;

FIG. 6 is a schematic diagram of a rear view of an electronic device at a second state, provided by certain embodiments of the present disclosure;

FIG. 7 is a schematic diagram of a structure of a display screen, provided in certain embodiments of the present disclosure;

FIG. 8 is a schematic diagram of a structure of a display screen, provided in certain embodiments of the present disclosure;

FIG. 9 is a schematic diagram of a front view of an electronic device at a first state, provided in certain embodiments of the present disclosure; and

FIG. 10 is a schematic diagram of a front view of an electronic device at a second state, provided in certain embodiments of the present disclosure.

### DETAILED DESCRIPTION

In certain embodiments, the present disclosure provides an electronic device for improving operational stability.

The following, combined with the accompanying drawings, describes the technical solutions in certain embodiments of the present disclosure. Certain embodiments as described represent only a portion of the embodiments of the present disclosure, and not all of them. Other embodiments derived by persons of ordinary skill in the technical field based on certain embodiments of the present disclosure without creative effort are within the scope of protection of the present disclosure.

In certain embodiments, the present disclosure provides that in an electronic device (such as a laptop or folding phone) having a first body with a display and a second body with components such as a motherboard, the second body has components such as a motherboard, which include heat-generating components (such as a CPU (Central Processing Unit/Processor), a GPU (Graphics Processing Unit), an NPU (Neural-network Process Units), a battery, or the like), and these heat-generating components are heat sources that may generate heat. When a display screen such as a folding screen or a rollable screen is stowed in the second body, the display screen is close to the above-mentioned heat source, which may easily cause the display screen to be affected by the temperature of the heat source and affect the reliability of the display screen, especially the heat-sensitive OLED (Organic Light Emitting Display) display screen.

Furthermore, since the display screen moves between the first and second bodies, the relative position of the first and second bodies may also affect the stability of the display screen.

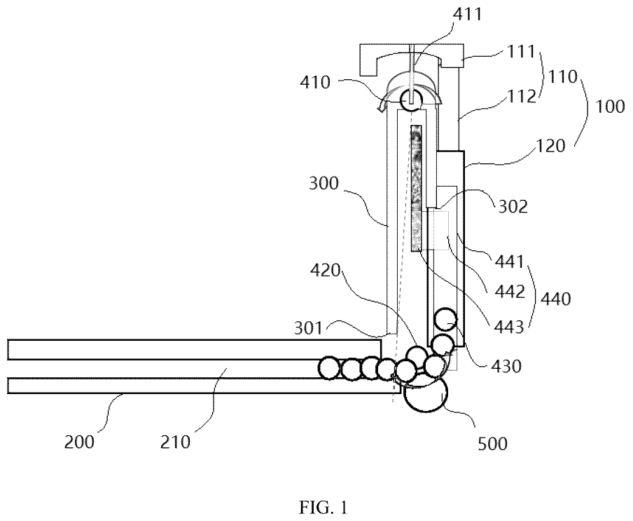

As shown in FIGS. 1-6, certain embodiments of the present disclosure provide an electronic device including a first body 100, a display screen 300, a second body 200, and an adjustment structure.

The first body 100 has a first surface. The first surface may have a display function, where a user may receive text and image information displayed on the first surface while performing at least one operation on the electronic device.

The display screen 300 is configured on the first body 100 and includes a first display area 310 that faces the same direction as the first surface. Therefore, when the display screen 300 is adjusted, the display screen 300 remains configured on the first body 100. The first display area 310 faces the same direction as the first surface, allowing the user to receive text and image information displayed on the first display area 310 while the user is facing the first surface or in other positions where the user may receive text and image information displayed on the first surface.

The second body 200 is connected to the first body 100 via a rotating connection structure 500. The second body 200 and the first body 100 may be together at a relatively unfolded state or a folded and stowed state for storage via the rotating connection structure 500. When the second body 200 and the first body 100 are together folded for storage, the first surface may be the side of the first body 100 facing the second body 200. In certain embodiments, the first surface may be the side of the first body 100 facing away from the second body 200. The second body 200 and the first body 100 are rotatably connected via the rotating connection structure 500. The structural arrangement of the rotating connection structure 500 allows the second body 200 and the first body 100 to rotate relative to each other at any angle, such as 90°, 180°, or 360°.

The adjustment structure is at least partially located on the second body 200 or the rotating connection structure 500, and is used to control the display screen 300 to switch between the first state and the second state. The portion of the adjustment structure located on the second body 200 or the rotating connection structure 500 may be a drive component (such as a motor), thereby avoiding the need for the adjustment structure to be located on the first body 100. This facilitates a thinner and lighter design for the first body 100 and also facilitates the layout of the display screen 300 being located on the first body 100.

Where, at the first state, the first display area 310 has a first size; at the second state, the first display area 310 has a second size, where the first size differs from the second size.

The first and second sizes may each be an area or a length of the first display area 310 along a linear direction.

For example, when the first size is larger than the second size:

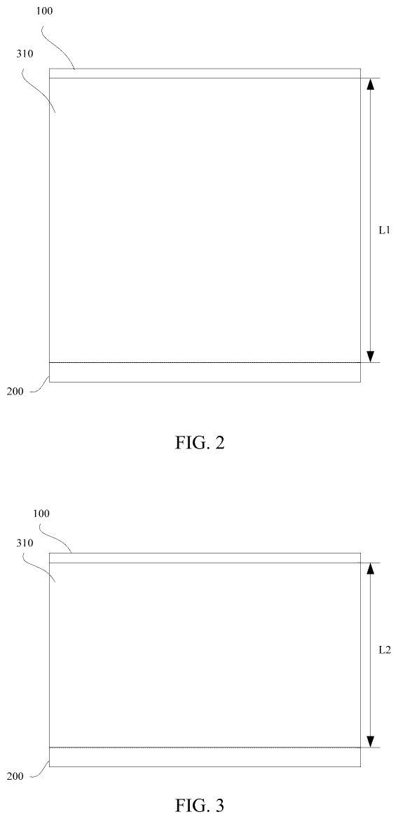

As shown in FIG. 2, at the first state, the lengthwise size of the first display area 310 is L1. As shown in FIG. 3, in the second state, the lengthwise size of the first display area 310 is L2. The lengthwise direction of the first display area 310 is the direction in which the first body 100 moves toward and away from the second body 200, and L1 is greater than L2. Assuming the widthwise size of the first display area 310 remains constant, the area of the first display area 310 at the first state is larger than the area at the second state.

In the electronic device provided by certain embodiments of the present disclosure, at the first state and the second state, the display screen 300 is configured on the first body 100, and the structure of the first display area 310 of the display screen 300 facing the same direction as the first surface may be adjusted under the adjustment of the adjustment structure. On the basis of meeting different usage requirements of the electronic device, the display screen 300 may be kept away from the heat source located on the second body, avoiding the heat of the heat source from affecting the display screen 300, thereby improving the reliability of the display screen 300.

The display screen 300 may be a rollable screen. The first state and the second state may be the unfolded state and the stowed state of the rollable screen, respectively. For example, when the first size is larger than the second size, the first state is the unfolded state, and the second state is the stowed state. The display screen 300 may also be another type of screen, as long as it may achieve relative deformation to achieve a change in the size of the first display area 310, which has the same orientation as the first surface, at the first state and at the second state.

In order to improve the usage mode of the electronic device and facilitate the flexible use of the electronic device by the user, the first body 100 has a second surface opposite to the first surface. Among them, the display screen 300 may have a second display area 320 with the same orientation as the second surface. Taking the above-mentioned first surface as the side facing the second body 200 when the second body 200 and the first body 100 are folded and stowed as an example, the second surface is the side facing away from the second body 200 when the second body 200 and the first body 100 are folded and stowed. The user may receive the information displayed in the second display area 320 without unfolding the second body 200 and the first body 100. That is, the part of the electronic device with the second display area 320 may be used as a secondary screen of the electronic device.

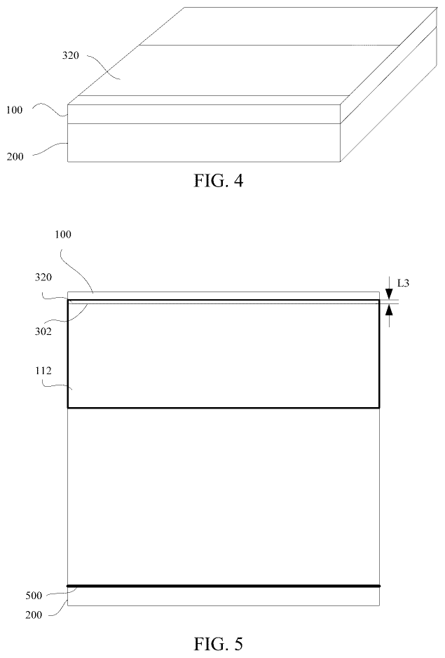

As shown in FIG. 4, when the second body 200 and the first body 100 are folded and stowed, the second surface of the first body 100, facing away from the second body 200, is exposed, and the second display area 320 of the display screen 300 is facing in the same direction as the second surface. Therefore, at this state, the user may receive information displayed in the second display area 320, so that the electronic device may display corresponding information such as received information and the battery level of the electronic device as a secondary screen. At the first state, the display screen 300 also has a second display area 320 facing in the same direction as the second surface, and the second display area 320 has a third size; alternatively, the first display area 310 is the entire display area of the display screen 300;

At the second state, the display screen 300 further includes a second display area 320 facing in the same direction as the second surface. The second display area 320 has a fourth size, and the third size differs from the fourth size.

Similarly, the third and fourth sizes may each be an area or a length of the second display area 320 along a linear direction.

For example, when the third size is smaller than the fourth size:

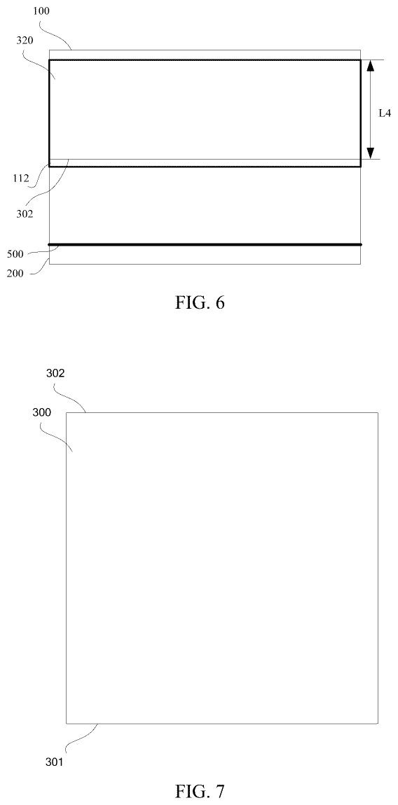

As shown in FIG. 5, at the first state, a lengthwise size of the second display area 320 is L3; as shown in FIG. 6, at the second state, a lengthwise size of the second display area 320 is L4. The lengthwise direction of the second display area 320 is the direction in which the first body 100 moves toward and away from the second body 200, and L3 is smaller than L4. Given a constant widthwise size of the second display area 320, the area of the second display area 320 at the first state is smaller than the area at the second state.

The display screen 300 in certain embodiments of the present disclosure may be a rollable screen, and the display screen 300 is controlled to switch between a first state and a second state by an adjustment structure, that is, the position of the display screen 300 on the first body 100 is adjusted. For example, when switched from the second state to the first state, the first display area 310 increases and the second display area 320 decreases; when switched from the first state to the second state, the first display area 310 decreases and the second display area 320 increases.

As shown in FIGS. 2, 3, 5, and 6, the rollable screen's structural adjustment allows for a portion to face the same direction as the first surface and another portion to face the same direction as the second surface. The area facing the same direction as the first surface is the first display area 310, and the area facing the same direction as the second surface is the second display area 320. Given a fixed overall size for the display screen 300, increasing the first display area 310 reduces the second display area 320, and increasing the second display area 320 reduces the first display area 310. In certain embodiments, L1+L3=L2+L4.

In order to help ensure that the information displayed in the second display area 320, which faces the same orientation as the second surface, may be received by the user without being blocked by the solid components of the first body 100 (such as the shell, or the like), the second surface of the first body 100 may be at least partially provided with a transparent component or a hollow structure so that the information displayed in the second display area 320 may be received by the user.

In certain embodiments, as shown in FIG. 1, the first body 100 may include a transparent cover 112, which is located on the second surface of the first body 100. The second display area 320 faces in the same direction as the second surface, so that the display information of the second display area 320 may be received by the user through the transparent cover 112. In certain embodiments, a hollow structure may be provided on the second surface of the first body 100, or the entire housing of the first body 100 located on the second surface may be provided as a transparent plate, or the like. The present disclosure does not limit such design and all suitable designs are within the scope of protection.

In certain embodiments, the display screen 300 has a first end 301 and a second end 302. As shown in FIG. 7, when the display screen 300 is flattened, the first end 301 and the second end 302 may be opposite ends of the display screen 300.

The first end 301 is fixedly connected to the first body 100, and the second end 302 is movably connected to the first body 100. The relative movement of the second end 302 and the first body 100 allows the structure of the display screen 300 on the first body 100 to be adjusted. The display screen 300 has a flexible portion that may deform along an alignment direction of the first end 301 and the second end 302. The flexible portion may deform at least along the alignment direction of the first end 301 and the second end 302, but may also deform in other directions. An adjustment structure may adjust the position of the second end 302 so that the position of the second end 302 relative to the first body 100 is different between the first and second states. In certain embodiments where the second end 302 is located at different positions relative to the first body 100, the flexible portion deforms in different structures, thereby achieving a size change of the first display area 310.

Through the above arrangement, the adjustment structure may adjust the position of the second end 302 to switch between states, facilitating the switching operation.

In certain embodiments, both the first end 301 and the second end 302 may be movably connected to the first body 100, and the adjustment structure may adjust the positions of the first end 301 and the second end 302 so that the positions of the first end 301 and the second end 302 relative to the first body 100 are different between the first state and the second state.

In the electronic device of certain embodiments of the present disclosure, the adjustment structure may include a first adjustment assembly and a second adjustment assembly. The first adjustment assembly is used to support the flexible portion and is capable of moving toward and away from the rotating connection structure 500. The second adjustment assembly is at least partially located in the second body 200 or the rotating connection structure 500, and is connected to the second end 302 to drive the second end 302 to move toward and away from the rotating connection structure 500. When the first end 301 is fixedly connected to the first body 100, the first adjustment assembly for supporting the flexible portion may move in the direction of approaching and moving away from the rotating connection structure 500, and the second adjustment assembly drives the second end 302 to move in the direction of approaching and moving away from the rotating connection structure 500, so that the positions of the two ends of the flexible portion (along the direction of the first end 301 and the second end 302) relative to the first body 100 may be adjusted, thereby causing the flexible portion to deform.

In certain embodiments where the second adjustment assembly is at least partially located within the second body 200, the second adjustment assembly may include a drive component disposed within a housing of the second body 200 and a connector (for example, flexible connector 430) connecting the drive component to the second end 302. The drive component drives the second end 302 to move via the connector. The connector may be driven by the drive component to move between the first body 100, the rotating connection structure 500, and the second body 200, thereby causing the second end 302 to move toward or away from the rotating connection structure 500.

In certain embodiments where the second adjustment assembly is at least partially located within the rotating connection structure 500, the second adjustment assembly may include a winding shaft coaxially disposed with the rotating axis of the rotating connection structure 500 (the winding shaft may be independent of the rotating axis or integrally formed). The winding shaft is connected to the second end 302 via a flexible component (such as the flexible connector 430). The winding shaft winds around the flexible component to enable the second end 302 to move toward and away from the rotating connection structure 500.

Because the first adjustment assembly may move toward and away from the rotating connection structure 500, the size of the area of the first body 100 located between the first end 301 and the first adjustment assembly may be adjusted accordingly.

In this embodiment, the first display area 310 is located between the first end 301 and the first adjustment assembly (first shaft 410), with the first end 301 positioned close to the rotating connection structure 500. That is, as the first adjustment assembly moves away from the rotating connection structure 500, the first adjustment assembly moves away from the position where the first end 301 is fixedly connected to the first body 100, causing the length of the first display area 310 along the alignment direction of the rotating connection structure 500 and the first adjustment assembly to increase. When the width of the display screen 300 (perpendicular to the alignment direction of the rotating connection structure 500 and the first adjustment assembly) remains constant, the area of the first display area 310 increases. That is, it switches to the first state. When the first adjustment assembly moves in a direction approaching the rotating connection structure 500, the first adjustment assembly approaches the position where the first end 301 is fixedly connected to the first body 100, causing the length of the first display area 310 along the arrangement direction of the rotating connection structure 500 and the first adjustment assembly to decrease. When the width of the display screen 300 (perpendicular to the arrangement direction of the rotating connection structure 500 and the first adjustment assembly) remains constant, the area of the first display area 310 decreases, that is, it switches to the second state.

To achieve the movement of the first adjustment assembly toward and away from the rotating connection structure 500, the first body 100 includes a first shell 110 and a second shell 120 that may move relative to each other. The first end 301 is fixedly connected to the second shell 120, the second body 200 is connected to the second shell 120 via the rotating connection structure 500, and the first adjustment assembly is connected to the first shell 110. The first shell 110 and the second shell 120 may be telescopically engaged to help ensure the integrity of the outer shell of the first body 100.

Where, at the first state, the first shell 110 moves relative to the second shell 120 to a first position, and the distance between the second end 302 and the rotating connection structure 500 is a first distance; at the second state, the first shell 110 moves relative to the second shell 120 to a second position, and the distance between the second end 302 and the rotating connection structure 500 is a second distance. The first position is farther away from the rotating connection structure 500 than the second position, and the second distance is smaller than the first distance.

As shown in FIG. 5, at the first state, the first shell 110 moves to the first position relative to the second shell 120, so that the first shell 110 and the second shell 120 are relatively unfolded, so that the dimensions of the first shell 110 and the second shell 120 in the alignment direction of the first adjustment assembly and the rotating connection structure 500 are increased, so that the area of the flexible portion that faces the same direction as the first surface is increased, that is, the size (area) of the first display area 310 is increased; the distance between the second end 302 and the rotating connection structure 500 is the first distance, that is, the second end 302 is away from the rotating connection structure 500 in order to cooperate with the deformation of the flexible portion.

As shown in FIG. 6, at the second state, the first shell 110 moves to the second position relative to the second shell 120, so that the first shell 110 and the second shell 120 shrink relatively, so that the dimensions of the first shell 110 and the second shell 120 in the alignment direction of the first adjustment assembly and the rotating connection structure 500 are reduced, so that the area of the flexible portion that faces the same direction as the first surface is reduced, that is, the size (area) of the first display area 310 is reduced; the distance between the second end 302 and the rotating connection structure 500 is the second distance, that is, the second end 302 is closer to the rotating connection structure 500 in order to cooperate with the deformation of the flexible portion.

The first adjustment assembly may be configured within the space formed within the first shell 110. Connected to the first shell 110 via connecting components such as a fixing beam 411, the first adjustment assembly may move synchronously with the movement of the first shell 110 relative to the second shell 120.

To prevent external dust and impurities from affecting the service life of the display screen 300 and the first adjustment assembly, the first shell 110 and the second shell 120 form a cavity, within which the display screen 300 and the first adjustment assembly are located.

In certain embodiments, the first shell 110 and the second shell 120 are components forming the housing of the first body 100. A hollow structure or a transparent plate may be provided on the first surface of the housing of the first body 100 so that the display information of the first display area 310 may be received by the user.

As shown in FIG. 1, the first shell 110 includes an end plate 111 and a transparent cover 112. In the first state and/or the second state, the second display area 320 of the display screen 300 may be arranged corresponding to the transparent cover 112, so that the user may see the display information of the second display area 320 through the transparent cover 112. The end plate 111 may be connected to the first adjustment assembly via a connecting component such as a fixing beam 411. The end plate 111 may also be configured as a transparent structure so that the display area of the flexible portion supported by the first adjustment assembly may be viewed by the user.

As shown in FIG. 5, at the first state, the size of the second display area 320 is relatively small or even absent. At the first state, when the second display area 320 is present, the second display area 320 is aligned with the transparent cover 112 along a first direction so that the display information of the second display area 320 may be accessed by the user. The first direction is the alignment direction of the first surface of the first body 100 and the second surface thereof.

As shown in FIG. 6, at the second state, the second display area 320 is relatively larger and aligned with the transparent cover 112 along the first direction, allowing the user to easily access the information displayed in the second display area 320.

To enhance the stability of the second end 302 during movement, the second shell 120 includes a sliding structure, with which the second end 302 slidably engages.

As shown in FIG. 1, the sliding structure may be an inner wall of the second shell 120. To facilitate sliding engagement between the second end 302 and the sliding structure, the second end 302 includes a sliding engagement structure 440. The sliding engagement structure 440 slides in engagement with the inner wall of the second shell 120, thereby achieving sliding engagement between the second end 302 and the sliding structure. In certain embodiments, the sliding engagement structure 440 is sleeved within the second shell 120 and is capable of sliding relative to the inner wall of the second shell 120. In certain embodiments, the sliding engagement structure 440 includes a sliding member 441, an intermediate member 442 and a connecting member 443. The intermediate member 442 connects the sliding member 441 and the connecting member 443. The sliding member 441 may slide with the inner wall of the second shell 120. The connecting member 443 is connected to a supporting surface of the display surface facing away from the display screen 300 to avoid blocking the display area of the display screen 300.

The connecting member 443 may be made of a flexible material, such as POM (Polyformaldehyde), which has a low coefficient of friction, thereby reducing frictional losses caused to the display screen 300 during the sliding process between the second end 302 and the sliding structure. In certain embodiments, the display screen 300 is bent under the support of the first adjustment assembly, so that the display surface of the display screen 300 is turned outward and the supporting surface of the display screen 300 is positioned opposite each other. The connecting member 443 is at least partially located in the gap formed by the bending of the display screen 300, thereby facilitating connection with the supporting surface of the display screen 300. In addition, the area where the connecting member 443 is exposed and faces the same direction as the second surface may be provided with an appearance pattern so that it may be exposed through the shell portion of the first body 100 located on the second surface (such as the transparent cover 112, or the like) to serve as a decorative surface or an icon with a corresponding reminder function, or the like.

In certain embodiments, the first adjustment assembly includes a first shaft 410 and a first drive member. The first shaft 410 contacts the support surface of the flexible portion, and the support surface faces away from the display surface of the display screen 300. The first drive member is used to drive the first shaft 410 to rotate, so as to provide a driving force to the support surface of the flexible portion to achieve switching between the first state and the second state. The first shaft 410 may be connected to the fixing beam 411 in a rotationally coordinated manner, or the first drive member may be fixedly connected to the fixing beam 411. The first shaft 410 may be directly connected to the driving end of the first drive member or indirectly connected through a transmission structure.

In certain embodiments, the first drive member may be a rotary drive component, such as a hub motor. The first drive member may be connected to components (such as a motherboard) within the second body 200 via a cable (dashed line in the figure) or wireless transmission, so that the driving force provided by the support surface of the flexible portion may be controlled accordingly by controlling the start and stop and operating speed of the first drive member. Since the support surface of the flexible portion is in contact with the first shaft 410, during the process of the first drive member driving the first shaft 410 to rotate, the first shaft 410 drives the support surface of the flexible portion to move along the circumference of the first shaft 410 under the action of friction force, thereby moving the contact position of the support surface of the flexible portion of the first shaft 410, adjusting the deformation structure of the flexible portion, and realizing switching between the first state and the second state.

In certain embodiments, the support surface of the flexible portion may have a friction structure to increase the friction between the first shaft 410 and the support surface of the flexible portion. The friction structure may include a concave-convex structure such as a rack structure or a diamond pattern to increase the roughness of the support surface of the flexible portion, thereby increasing the friction between it and the first shaft 410.

In certain embodiments, the second adjustment assembly includes a flexible connector 430 and a second drive member 420. The flexible connector 430 is connected to the second end 302; the second drive member 420 is used to adjust the position of the flexible connector 430, thereby moving the second end 302 toward and away from the rotating connection structure 500. In other words, the flexible connector 430 connects the second end 302 and the second drive member 420. Because the flexible connector 430 is flexible and deformable, it may be easily moved between the first body 100 and the second body 200.

As described above, the second drive member 420 may be a rotary drive component, such as a hub motor. The second drive member 420 may be connected to the flexible connector 430 via a second shaft. That is, the second drive member 420 drives the second shaft to rotate, thereby driving the flexible connector 430 to move its position. In certain embodiments, the flexible connector 430 may contact the second shaft, and friction exists at the contact point between the two. During the rotation of the second shaft, the flexible connector 430 is driven to move linearly, thereby achieving position adjustment of the flexible connector 430. In turn, the flexible connector 430 drives the second end 302 to move toward and away from the rotating connection structure 500. The flexible connector 430 may also be wound around the second shaft, and the second shaft may be rotated to wind or unfold the flexible connector 430, thereby adjusting the position of the flexible connector 430, and then the flexible connector 430 drives the second end 302 to move toward and away from the rotating connection structure 500.

In certain embodiments, the second drive member 420 may be a rotating shaft (for example, a second shaft), and the rotating connection structure 500 may cooperate with the second drive member 420 to achieve movement of the flexible connector 430. For example, the flexible connector 430 may be clamped between the rotating shaft of the rotating connection structure 500 and the second shaft of the second drive member 420. During the relative unfolding of the first body 100 and the second body 200, the rotating shaft of the rotating connection structure 500 rotates, thereby driving the flexible connector 430 to move under the action of the second shaft of the second drive member 420.

In certain embodiments, the first adjustment assembly and the second adjustment assembly may be relatively independent, that is, the first adjustment assembly is set on the first body 100, and the second adjustment assembly is set on the second body 200 or the rotating connection structure 500. The first adjustment assembly and the second adjustment assembly are independently controlled by the system of the electronic device.

In certain embodiments, the first adjustment assembly and the second adjustment assembly may be connected, for example, by using the same drive component to drive the movement of the first adjustment assembly and the second adjustment assembly. In certain embodiments, the first shaft 410 of the first adjustment assembly and the second shaft of the second drive member 420 are driven by the same drive member (motor), and the two are connected by a transmission structure.

In certain embodiments, the flexible connector 430 may be connected to the sliding member 441.

During the transition between the first and second states, the first drive member and the second drive member 420 may operate synchronously and coordinate with the relative movement of the first and second shells 110 and 120.

As shown in FIG. 1, the first end 301 is located on the same side of the first shaft 410 and the second shaft, and the second end 302 is located on the same side of the first shaft 410 and the second shaft. Therefore, the rotational direction of the first shaft 410 driven by the first drive member is the same as the rotational direction of the second shaft driven by the second drive member 420. The speed at which the first shaft 410 drives the flexible portion is consistent with the speed at which the second shaft drives the second end 302 via the flexible connector 430. In certain embodiments, when the flexible connector 430 is in an extended state, the linear velocity of the first shaft 410 is consistent with the linear velocity of the second shaft; when the flexible connector 430 is in a contracted state, the linear velocity of the first shaft 410 is less than the linear velocity of the second shaft. For example, the flexible connector 430 is a chain structure, and there is an engagement gap between the connecting parts of the chain, so that the two ends of the chain structure may be relatively close and relatively extended. At the extended state, the length of the chain structure is the longest, and the linear speed of the second shaft may be consistent with the moving speed of the second end 302; at the contracted state, the linear speed of the second shaft may be the sum of the extending speed of the chain structure and the moving speed of the second end 302.

To achieve a lightweight and thin design for the first body 100, in certain embodiments, the outer diameter of the first shaft 410 is no greater than 5 mm (millimeters), and more particularly, no greater than 2 mm. The number of first drive members may be one, for example, a single power source may be used to drive the first shaft 410; the number of first drive members may also be multiple, for example, multiple coaxial power sources may be used to drive the first shaft 410.

In certain embodiments, the second body 200 has a receiving space 210 for receiving the flexible connector 430. During the switching process to the first state, the second end 302 moves away from the rotating connection structure 500, and the flexible connector 430 at least partially moves out of the receiving space 210. During the switching process to the second state, the second end 302 moves toward the rotating connection structure 500, and the flexible connector 430 at least partially moves into the receiving space 210. That is, during the switching process between the first state and the second state, the flexible connector 430 moves relative to the receiving space 210, so that the flexible connector 430 may at least partially move out of or into the receiving space 210.

In certain embodiments, the receiving space 210 may be a component cavity within the housing of the second body 200, or a cavity formed by the housing of the second body 200.

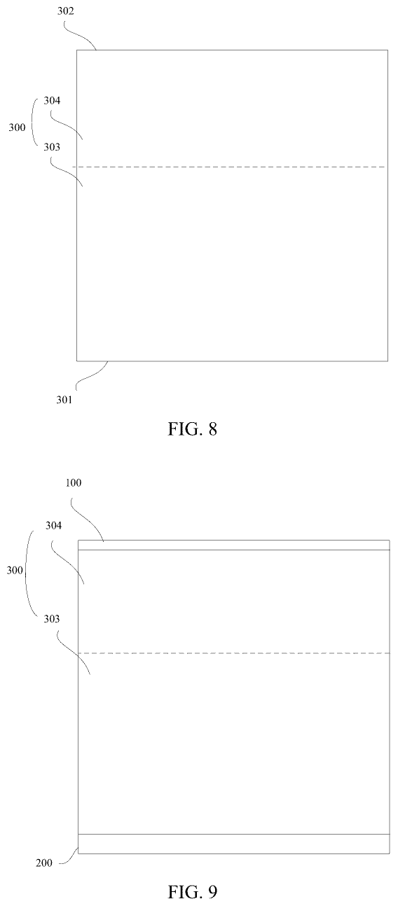

As shown in FIG. 8, in certain embodiments, the display screen 300 may include a flexible portion 304 and a rigid portion 303 that are interconnected. The rigid portion 303 has a first end 301 and a third end, and the flexible portion 304 has a second end 302 and a fourth end, with the third end and the fourth end connected. That is, the flexible portion 304 and the rigid portion 303 are arranged along the length of the display screen 300 (the direction in which the first end 301 and the second end 302 of the display screen 300 are aligned).

The orientation of the rigid portion 303 is the same as that of the first surface, that is, at both the first and second states, the display surface of the rigid portion 303 always belongs to the first display area 310. By adjusting the position of the flexible portion 304, the display surface of the flexible portion 304 may be entirely in the first display area 310, entirely in the second display area 320, or partially in the first display area 310 and partially in the second display area 320.

The adjustment structure may adjust the orientation of the display surface of the flexible portion 304. When the orientation of the display surface of the flexible portion 304 is the same as the orientation of the first surface, the display surface of the flexible portion 304 belongs to the first display area 310. When the orientation of the display surface of the flexible portion 304 is the same as the orientation of the second surface, the display surface of the flexible portion 304 belongs to the second display area 320. When the orientation of a first portion of the display surface of the flexible portion 304 is the same as the orientation of the first surface and the orientation of a second portion of the display surface of the flexible portion 304 is the same as the orientation of the second surface, the first portion belongs to the first display area 310 and the second portion belongs to the second display area 320.

As shown in FIG. 9, at the first state, the display surface of the rigid portion 303 always belongs to the first display area 310. When all or most of the display surface of the flexible portion 304 faces in the same direction as the first surface, then that portion belongs to the first display area 310.

In certain embodiments, the rigid portion 303 and the flexible portion 304 may function as two relatively independent display screens. That is, the display content of the rigid portion 303 and the flexible portion 304 may be relatively independent. One of the rigid portion 303 and the flexible portion 304 may function as the primary screen, while the other may function as a secondary screen or second screen. The user may control the display content of the rigid portion 303 and the display content of the flexible portion 304 separately.

In certain embodiments, the rigid portion 303 and the flexible portion 304 function as a single display screen. That is, the display surface of the rigid portion 303 and the display surface of the flexible portion 304 may both display the same image information. This allows for a larger display area, thereby satisfying the user's need for a larger screen.

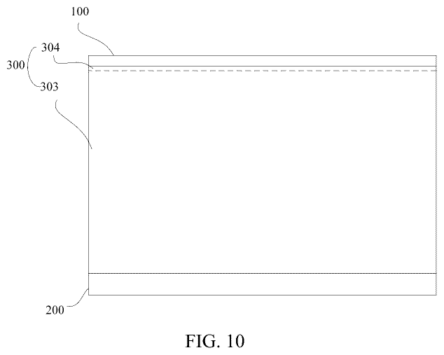

As shown in FIG. 10, at the second state, the display surface of the rigid portion 303 always belongs to the first display area 310. When the display surface of the small portion of the flexible portion 304 faces in the same direction as the first surface, this portion belongs to the first display area 310.

As shown in FIG. 7, in certain embodiments, the display screen 300 is a flexible screen having a first end 301 and a second end 302. That is, the display screen 300 as a whole is capable of deforming along the alignment direction of the first end 301 and the second end 302.

Various embodiments are described, with each embodiment focusing on its differences from other embodiments. Similar or identical parts between the various embodiments may be referenced for clarity.

The above description of the disclosed embodiments is intended to enable one skilled in the technical field to implement or use the present disclosure. Various modifications to these embodiments are readily apparent to one skilled in the technical field, and the general principles defined herein may be implemented in other embodiments without departing from the spirit or scope of the present disclosure. Therefore, the present disclosure is not limited to the embodiments shown herein, but is intended to conform to the widest scope consistent with the principles and novel features disclosed herein.

What is claimed is:

1. An electronic device, comprising:
a first body, the first body having a first surface;
a display screen, the display screen being on the first body, the display screen having a first display area facing in a same direction as the first surface;
a second body, the second body connected to the first body via a rotating connection structure; and
an adjustment structure, the adjustment structure at least partially located in the second body or the rotating connection structure, the adjustment structure being configured to control the display screen to switch between a first state and a second state, wherein
at the first state, the first display area has a first size,
at the second state, the first display area has a second size, and the first size being different from the second size.

2. The electronic device of claim 1, wherein the first body has a second surface opposite to the first surface, wherein
at the first state, the display screen further has a second display area facing in a same direction as the second surface, the second display area having a third size; or the first display area is an entire display area of the display screen,
at the second state, the second display area has a fourth size, and the third size differs from the fourth size.

3. The electronic device of claim 1, wherein the display screen has a first end and a second end; the first end is fixedly connected to the first body, and the second end is movably connected to the first body; the display screen has a flexible portion that is deformable along an alignment direction of the first and second ends; and the adjustment structure is capable of adjusting a position of the second end so that a position of the second end relative to the first body is different between the first state and the second state.

4. The electronic device of claim 3, wherein the adjustment structure includes:
a first adjustment assembly, the first adjustment assembly being configured to support the flexible portion and being movable toward and away from the rotating connection structure;
a second adjustment assembly, the second adjustment assembly being at least partially located within the second body or the rotating connection structure and connected to the second end for driving the second end to move toward and away from the rotating connection structure.

5. The electronic device of claim 4, wherein the first body includes a first shell and a second shell that are movable relative to each other, the first end being fixedly connected to the second shell, the second body and the second shell being connected via the rotating connection structure, and the first adjustment assembly being connected to the first shell;
at the first state, the first shell moves relative to the second shell to a first position, and a distance between the second end and the rotating connection structure is a first distance;
at the second state, the first shell moves relative to the second shell to a second position, and a distance between the second end and the rotating connection structure is a second distance, the first position being farther from the rotating connection structure in comparison to the second position, and the second distance being smaller than the first distance.

6. The electronic device of claim 5, wherein the first shell and the second shell define a cavity, and the display screen and the first adjustment assembly are located within the cavity.

7. The electronic device of claim 5, wherein the second shell has a sliding structure, and the second end slidably engages with the sliding structure.

8. The electronic device of claim 4, wherein the first adjustment assembly includes:
a first shaft, the first shaft being in contact with a support surface of the flexible portion, the support surface facing away from a display surface of the display screen;
a first drive member, the first drive member being configured to rotate the first shaft to provide a driving force to the support surface of the flexible portion, thereby realizing a switch between the first and second states;
and/or,
the second adjustment assembly includes:
a flexible connector, the flexible connector being connected to the second end;
a second drive member, the second drive member being configured to adjust a position of the flexible connector to cause the second end to move toward and away from the rotating connection structure.

9. The electronic device of claim 8, wherein the second body has a receiving space for receiving the flexible connector;
in a process of switching to the first state, the second end moves away from the rotating connection structure, causing the flexible connector to at least partially move out of the receiving space;
in a process of switching to the second state, the second end moves toward the rotating connection structure, causing the flexible connector to at least partially move into the receiving space.

10. The electronic device of claim 3, wherein the display screen includes a flexible portion and a rigid portion connected to each other, the rigid portion including the first end and a third end, the flexible portion including the second end and a fourth end, the third end being connected to the fourth end;
or, the display screen is a flexible screen, wherein the flexible screen includes the first end and the second end.

11. An electronic device, comprising:
a first body, including a first surface and a second surface opposing the first surface;
a display screen, including a flexible portion, wherein the flexible portion includes a first portion supported on the first surface and a second portion supported on the second surface; and
a second body, connected to the first body via a rotating connection structure, wherein the rotating connection structure is positioned between the flexible portion and the second body.

12. The electronic device of claim 11, wherein the second body is configured to include a heat-generating component, and the heat-generating component includes a processor.

13. The electronic device of claim 11, wherein at a first state, the first portion is greater than the second portion, and at a second state, the first portion is smaller than the second portion.

14. The electronic device of claim 13, wherein at the second state, the first surface is positioned between the second surface and the second body.

15. The electronic device of claim 11, further comprising:
a transparent cover, configured to cover at least partially the second portion of the flexible portion.

16. The electronic device of claim 15, wherein the rotating connection structure is positioned between the transparent cover and the second body.

17. The electronic device of claim 11, further comprising:
a first shaft, configured to support movement of the flexible portion.

18. The electronic device of claim 17, wherein the rotating connection structure is positioned between the first shaft and the second body.

19. The electronic device of claim 17, further comprising:
an end plate, configured to support the first shaft.

20. An electronic device, comprising:
a first body, including a first surface and a second surface opposing the first surface;
a display screen, including a flexible portion, wherein the flexible portion includes a first portion supported on the first surface and a second portion supported on the second surface;
a first shaft, configured to support movement of the flexible portion; and
a second body, connected to the first body via a rotating connection structure, wherein the rotating connection structure is positioned between the flexible portion and the second body; and
a transparent cover, configured to cover at least partially the second portion of the flexible portion.
